(19) United States
(12) Patent Application Publication
(10) Pub. No.: US 2003/0198814 A1
(43) Pub. Date: Oct. 23, 2003

(54) Retroreflective sheeting comprising thin continuous hardcoat

(75) Inventors: Sithya S. Khieu, Eden Prairie, MN (US); Gregory E. Gilligan, Hastings, MN (US); Moses M. David, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/128,083

(22) Filed: Apr. 23, 2002

(51) Int. Cl. B32B 27/36

(52) U.S. Cl. 428/412

(57) ABSTRACT

The invention relates to retroreflective sheeting and articles suitable for pavement marking comprising a retroreflective layer and a thin continuous hardcoat layer comprising an inorganic oxide material or diamond-like carbon material on the outermost exposed surface. Preferably, at least one intermediate layer is provided between the retroreflective layer and hardcoat layer.

### FIELD OF THE INVENTION

The invention relates to retroreflective sheeting and articles suitable for pavement marking comprising a retroreflective layer and a thin continuous hardcoat layer comprising an inorganic oxide material or diamond-like carbon material on the outermost exposed surface. Preferably, at least one intermediate layer is provided between the retroreflective layer and hardcoat layer.

### BACKGROUND OF THE INVENTION

Retroreflective pavement marking tapes and raised pavement markers are used to delineate traffic lanes on roadways. The raised markers are typically employed to improve driver visibility at night especially in wet conditions, in comparison to standard stripes of retroreflective paint or tape. Examples of various raised pavement marker designs include U.S. Pat. No. 3,332,327 (Heenan); U.S. Pat. No. 3,409,344 (Balint); U.S. Pat. No. 4,875,798 (May); U.S. Pat. No. 5,667,335 (Khieu et al.); and U.S. Pat. No. 6,127,020 (Bacon Jr. et al.). These patents all describe marker designs that include a vertically sloping face that presents a prismatic reflector toward oncoming traffic. Various pavement marking tapes are described in, for example, U.S. Pat. No. 4,117,192 (Jorgenson); U.S. Pat. No. 4,282,281 (Ethen); and U.S. Pat. No. 4,490,432 (Jordan). Pavement marking tapes and in particular, raised pavement markers are subject to abrasion and impact from vehicle tires. Such abrasion and impact cause scratches and deformation on the retroreflective surface that create optical defects that block or scatter incident light from vehicle headlamps, diminishing the retroreflected brightness of the pavement markers and tape.

A number of approaches have been described to improve abrasion resistance and/or impact resistance. For example, U.S. Pat. No. 4,340,319 (Johnson, et al) describes a pavement marker that comprises a lens member of light-transmitting synthetic resin including a front face having a light-receiving and refracting portion adapted at an angle of at least 15° and a rear face having reflex reflective means for reflecting light transmitted through the light-receiving surface and refracting a portion back to the source. The pavement marker has an untempered glass sheet fixedly disposed on the light-receiving and refraction portion and the glass is in compression throughout the expected temperature range to which the pavement marker is exposed in use. The glass sheet may be adhesively bonded to the lens member by first applying an adhesive coating to the glass sheet or to the lens member and then placing the glass sheet in position on the lens member with the adhesive therebetween. Alternatively, the glass sheet may be bonded to the lens member during molding of the lens member. A very thin sheet of a transparent glass is provided for lamination to the lens member, the glass sheet preferably being untempered and having a thickness in the range from about 2 mils to about 15 mils. It has subsequently been found that the glass face has poor impact strength and is subject to cracking and chipping.

U.S. Pat. No. 4,753,548 (Forrer) describes a pavement marker with a photopolymerizable clear acrylic protective hard coat deposited over the front face of the lens for resisting abrasion of the lens and reducing the loss of optical efficiency resulting from such abrasion. However, such acrylic hardcoat material is softer than sand particles present on a roadway. Thus, the coated reflector is still subject to abrasion and scratching with resulting loss of retroreflective performance.

U.S. Pat. No. 5,677,050 (Bilkadi, et al.) describes retroreflective sheeting having an abrasion resistant ceramer coating that is prepared from about 20% to about 80% ethylenically unsaturated monomers; about 10% to about 50% of acrylate functionalized colloidal silica; and about 5% to about 40% N,N-disubstituted acrylamide or N-substituted N-vinyl-amide monomer having a molecular weight between 99 and 500 atomic mass unites; wherein said percentages are weight percentages of the total weight of said coating. Films (of the cured ceramer) between 4 and 9 micrometers in thickness have desirable properties such as good adhesion and abrasion resistance. Since the colloidal silica is provided in a particulate form, the surface is not continuous with regard to the presence of silica.

U.S. Pat. No. 5,927,897 (Attar) relates to a pavement marker comprising a housingless flat topped body and a reflective member embedded in the body. The body can be made of abrasion and impact resistant curable resinous filler material such as epoxy or polyester resin. The body and the reflective member can be coated with a high abrasion resistant diamond like carbon film to enhance durability and retain reflectivity. In a preferred embodiment, the reflective member is provided on the side of recesses of cells, each cell having a partition and load carrying walls.

### SUMMARY OF THE INVENTION

The present invention relates to retroreflective sheeting, suitable for pavement marking. The sheeting comprises a retroreflective layer having an exposed surface and a thin continuous hardcoat layer comprising an inorganic oxide material or a diamond-like carbon material disposed on the exposed surface of the sheeting. For embodiments wherein the hardcoat comprises an inorganic oxide material, the thickness of the hardcoat layer is preferably less than about 20 microns and more preferably less than about 10 microns. The thickness of the inorganic oxide hardcoat layer is typically at least about 0.5 microns, preferably at least about 1.0 micron, and more preferably at least about 2.0 micron. For embodiments wherein the hardcoat comprises diamond-like carbon, the thickness of the hardcoat layer is typically less than 10 microns and preferably less than about 5 microns. The thickness of the diamond-like carbon hardcoat layer is preferably at least about 200 angstroms, preferably at least about 400 angstroms, and more preferably at least about 800 angstroms. The hardcoat layer has a hardness equal to or greater than sand such as in the case of inorganic oxide materials that comprises a major amount of an inorganic oxide selected from TiO₂, Al₂O₃, ZrO₂, ZnO and SiO₂. The hardcoat layer is preferably applied by thermal or plasma enhanced chemical vapor deposition. Such hardcoat compositions are typically transparent.

In preferred embodiments, the sheeting further comprises an intermediate layer disposed between the retroreflective layer and the thin continuous hardcoat layer. The intermediate layer preferably has a hardness and/or flexural strength less than the hardcoat layer and greater than the retroreflective layer. The intermediate layer has good adhesion to both the retroreflective layer and the hardcoat layer.

In other embodiments, the present invention relates to retroreflective articles comprising the retroreflective sheeting having the thin continuous hardcoat layer on the exposed surface of the sheeting. Such articles typically further comprise a backing such as a body member comprising a resinous material and inert additives. The body member preferably comprises at least one vertically inclined face or at least one elevated horizontal face and the retroreflective layer is disposed on the vertically inclined face and/or the horizontally elevated face. The backing may comprise a conformable polymeric material comprising fibers. Further, the backing may comprise an adhesive on a surface opposing the viewing surface of the retroreflective sheeting.

### DETAILED DESCRIPTION OF THE PREFERRED EMBODIMENTS

The invention generally relates to retroreflective articles that are suitable for pavement marking uses. The articles generally comprise a retroreflective layer and a thin continuous hardcoat layer as the outermost exposed layer. The hardcoat layer preferably comprises an inorganic oxide material or a diamond-like carbon material. The hardcoat layer is “transparent” meaning that sufficient light is transmitted such that the retroreflective properties of the article are acceptable. Preferably, an intermediate layer is provided between the retroreflective layer and the hardcoat layer for the purpose of improving adhesion and for providing a gradient of hardness and flexural strength between such layers.

The retroreflective properties of the article are provided by a retroreflective layer (e.g. retroreflective sheeting). The retroreflective layer may exhibit such retroreflective properties independently or the retroreflective property may result upon completion of the optics upon combining the layer with an intermediate layer and/or the hardcoat layer. The retroreflective layer is typically preformed sheeting. The two most common types of retroreflective sheeting are microsphere-based sheeting and cube corner-based sheeting.

Microsphere-based sheeting, sometimes referred to as “beaded sheeting,” is well known in the art and includes a multitude of microspheres typically at least partially embedded in a binder layer, and associated specular or diffuse reflecting materials (such as metallic vapor or sputter coatings, metal flakes, or pigment particles). “Enclosed-lens” based sheeting refers to retroreflective sheeting in which the beads are in spaced relationship to the reflector but in full contact (i.e. covered) with resin. The “encapsulated lens” retroreflective sheeting is designed such that the reflector is in direct contact with the bead but the opposite side of the bead is in a gas interface. Illustrative examples of microsphere-based sheeting are disclosed in U.S. Pat. No. 4,025,159 (McGrath); U.S. Pat. No. 4,983,436 (Bailey); U.S. Pat. No. 5,064,272 (Bailey); U.S. Pat. No. 5,066,098 (Kult); U.S. Pat. No. 5,069,964 (Tolliver); and U.S. Pat. No. 5,262,225 (Wilson).

Cube corner sheeting, sometimes referred to as prismatic, microprismatic, triple mirror or total internal reflection sheetings, typically include a multitude of cube corner elements to retroreflect incident light. Cube corner retroreflectors typically include a sheet having a generally planar front surface and an array of cube corner elements protruding from the back surface. Cube corner reflecting elements include generally trihedral structures that have three approximately mutually perpendicular lateral faces meeting in a single corner—a cube corner. In use, the retroreflector is arranged with the front surface disposed generally toward the anticipated location of intended observers and the light source. Light incident on the front surface enters the sheet and passes through the body of the sheet to be reflected by each of the three faces of the elements, so as to exit the front surface in a direction substantially toward the light source. In the case of total internal reflection, the air interface must remain free of dirt, water and adhesive and therefore is enclosed by a sealing film. The light rays are typically reflected at the lateral faces due to total internal reflection, or by reflective coatings, as previously described, on the back side of the lateral faces. Preferred polymers for cube corner sheeting include polycarbonate), poly(methyl methacrylate), poly(ethylene terephthalate), aliphatic polyurethanes, as well as ethylene copolymers and ionomers thereof. Cube corner sheeting may be prepared by casting directly onto a film, such as described in U.S. Pat. No. 5,691,846 (Benson, Jr.) incorporated herein by reference. Preferred polymers for radiation cured cube corners include cross-linked acrylates such as multifunctional acrylates or epoxies and acrylated urethanes blended with mono-and multifunctional monomers. Further, cube corners such as those previously described may be cast on to plasticized polyvinyl chloride film for more flexible cast cube corner sheeting. These polymers are preferred for one or more reasons including thermal stability, environmental stability, clarity, excellent release from the tooling or mold, and capability of receiving a reflective coating.

In embodiments wherein the sheeting is likely to be exposed to moisture, the cube corner retroreflective elements are preferably encapsulated with a seal film. In instances wherein cube corner sheeting is employed as the retroreflective layer, a backing layer may be present for the purpose of opacifying the article or article, improving the scratch and gouge resistance thereof, and/or eliminating the blocking tendencies of the seal film. Illustrative examples of cube corner-based retroreflective sheeting are disclosed in U.S. Pat. No. 4,588,258 (Hoopman); U.S. Pat. No. 4,775,219 (Appledorn et al.); U.S. Pat. No. 4,895,428 (Nelson); U.S. Pat. No. 5,138,488 (Szczech); U.S. Pat. No. 5,387,458 (Pavelka); U.S. Pat. No. 5,450,235 (Smith); U.S. Pat. No. 5,605,761 (Burns); U.S. Pat. No. 5,614,286 (Bacon Jr.) and U.S. Pat. No. 5,691,846 (Benson, Jr.).

The retroreflective layer is typically bonded to a backing member. In the case of raised pavement markers the backing is preferably a body member that is molded from resinous material that can contain substantial amounts of inert additives. Representative raised pavement markers are described in U.S. Pat. No. 3,332,327 (Heenan), U.S. Pat. No. 3,409,344 (Balint), U.S. Pat. No. 4,875,798 (May) and U.S. Pat. No. 5,927,897 (Attar); incorporated herein by reference. In the case of raised pavement markers it is preferred to employ cube corner type sheeting or enclosed-lens type sheeting on a vertically inclined face of the body member. Alternatively or in addition thereto, retroreflective sheeting (e.g. exposed lens) may also be present on an elevated horizontal face (i.e. a face parallel, yet above the surface of the road).

In the case of pavement marking tapes, the sheeting is typically bonded to an extruded sheet comprising a polymeric material and an appreciable amount of fibers or to a thin conformable foil.

For pavement marking tapes having good wet retroreflectivity it is preferred to employ an enclosed lens type sheeting in a substantially horizontal orientation (i.e. parallel with the road surface). In order to provide good dry reflectivity, exposed lens type sheeting may be provided in a substantially horizontal orientation and/or enclosed lens or cube corner type sheeting provided in a substantially vertical orientation. Various combinations of these features can be incorporated into a single tape, such as described in U.S. Pat. No. 6,127,020 (Bacon, Jr.).

In the present invention, a thin continuous hardcoat layer is provided above the retroreflective layer as the outermost exposed layer of the article. The thin continuous hardcoat layer provides the abrasion and mar resistance.

Any suitable hardcoat material may be employed in the present invention provided that the hardcoat layer is sufficiently transparent, provided in a continuous layer and is at least as hard as the abrasive particles (i.e. sand) the outermost surface is subjected to.

Suitable inorganic oxides include TiO₂, Al₂O₃, ZrO₂, ZnO and SiO₂. Preferred inorganic oxide materials comprise a major amount of SiO₂, such as in the case of glass. However, for further improvements in durability, abrasion resistance, etc. glass-ceramic materials may alternatively be employed. Other suitable inorganic materials may include carbides and nitrides such as SiC and Si₃N₄.

Alternatively, thin carbon films or coatings in the form of graphite, diamond, diamond-like carbon (“DLC”), hydrogenated diamond-like carbon and amorphous carbon may be employed as the hardcoat layer. These films and coatings have a range of physical and chemical properties depending on the extent of diamond-like sp3 bonding versus graphite-like sp2 bonding. The term “diamond-like” is generally applied to non-crystalline material in which the diamond-like (sp3) tetrahedral bonds predominate. As used herein, the term “diamond-like film” refers to substantially or completely amorphous films comprised of carbon, and optionally comprising one or more additional components selected from the group consisting of hydrogen, nitrogen, oxygen, fluorine, silicon, sulfur, titanium, and copper. Other elements may be present in certain embodiments. The films may be covalently coupled or interpenetrating. The amorphous diamond-like films of this invention may contain clustering of atoms that give it a short-range order but are essentially void of medium and long range ordering that lead to micro or macro crystallinity which can adversely scatter radiation having wavelengths of from 180 nm to 800 nm.

The diamond-like films typically comprise on a hydrogen-free basis at least 25 atomic percent carbon, 0 to 50 atomic percent silicon, and 0 to 50 atomic percent oxygen. “Hydrogen-free basis” refers to the number of atoms present of all chemical elements other than hydrogen and its isotopes. In some embodiments, the film comprises between 25 and 100 atomic percent carbon, between 20 and 40 atomic percent silicon, and between about 20 and 40 atomic percent oxygen. In other embodiments, the film comprises from 30 to 36 atomic percent carbon, from 26 to 32 atomic percent silicon, and from 35 to 41 atomic percent oxygen on a hydrogen-free basis.

Various diamond-like films are suitable for the present invention, including diamond-like films selected from the group comprising diamond-like carbon, diamond-like glass, diamond-like networks, and interpenetrating diamond-like nanocomposites The simplest of these are the DLC films that consist of carbon and optionally up to 70% hydrogen. In DLC films, hydrogen saturates the dangling bonds. Hydrogen addition increases the optical transparency of the DLC films by reducing double bonds and conjugation of double bonds in the films. The next class of suitable diamond-like films includes diamond-like networks (“DLN”). In DLN, the amorphous carbon-based network is doped with other elements in addition to hydrogen. These may include fluorine, nitrogen, oxygen, silicon, copper, iodine, boron, etc. DLN contains at least 25% carbon. Typically the total concentration of these one or more additional elements is low (less than 30%) in order to preserve the diamond-like nature of the films. A further class of useful diamond-like film materials is diamond-like glass (“DLG”), in which the amorphous carbon structure consists of a substantial quantity of silicon and oxygen, as in glass, yet still retains diamond-like properties. In these films, on a hydrogen-free basis, there is at least 30% carbon, a substantial amount of silicon (at least 25%) and not more than 45% oxygen. The unique combination of a fairly high amount of silicon with a significant amount of oxygen and a substantial amount of carbon makes these films highly transparent and flexible (unlike glass). In addition, a class of interpenetrating diamond-like films is useful in this invention. These diamond-like thin films are called DYLYN and are interpenetrating networks of two materials. These interpenetrating diamond-like thin films are disclosed in U.S. Pat. No. 5,466,431 and U.S. Pat. No. 5,466,431, incorporated herein by reference

The hardcoat layer (i.e. coating or film) is sufficiently transparent such that the presence of such film does not substantially diminish the intended retroreflected brightness of the pavement marking article. For the majority of pavement marking tape uses, the coefficient of retroreflected luminance (R_{L}) of the sheeting or article as measured according to ASTM E 1710 using a retroreflectometer that measures at 30 meter CEN (i.e. Comite Europeen De Normalisation in French or European Committee for Standardization in English) geometry is typically initially at least 100 mcd/m²/lux and preferably at least 300 mcd/m²/lux. Preferably, the pavement marking articles substantially retain their retroreflected luminance for extended durations of use, for example for at least 1 year, preferably at least 2 years, and more preferably at least 4 years.

Generally, hardcoat layers comprising inorganic oxide materials (e.g. SiO₂) are provided at a thickness of less than about 25 microns, preferably less than about 20 microns and more preferably less than about 10 microns. At too high of a thickness, the inorganic oxide layer is increasingly susceptible to cracking and chipping. Accordingly, the inorganic oxide layer is generally provided in a continuous film at a thickness as thin as possible. The inorganic oxide layer is typically at least about 0.5 microns, preferably at least about 1.0 micron and more preferably at least about 2.0 microns thick. Diamond-like carbon hardcoat layers are preferably employed at a thickness of less than about 10 microns and preferably less than about 5 microns. At higher thickness, the retroreflective brightness can be impaired, particularly in the case of DLC approaching the properties of graphite (i.e. increasing sp2 bonding). Further, the thickness of the diamond-like carbon layer is preferably at least about 200 angstroms, preferably at least about 400 angstroms, and more preferably at least about 800 angstroms.

The outermost hardcoat layer can be applied by a variety of deposition process techniques under the general category of chemical vapor deposition (“CVD”). Deposition technologies in the CVD category include for example thermal CVD and plasma-enhanced CVD (“PECVD”). Suitable methods of PECVD include, radio frequency (“Rf”) capacitive, Rf inductive, microwave, jet plasma, ion-beam deposition, hollow cathode deposition, etc. In particular, plasma deposition, such as described in U.S. Pat. No. 5,888,594, is preferred for depositing DLC. The maximum thickness of the hardcoat layer (e.g. SiO₂ or DLC) is generally limited by the compressive forces that are generated in the layer during the deposition process. Further, excessively long processing times required to deposit thick layers result in the pavement marking articles being economically less feasible.

It has been found that it is preferred to employ at least one intermediate layer between the retroreflective layer and the continuous hardcoat layer. This intermediate layer may serve one or more purposes in the assembly of the article. Typically the hardcoat layer does not sufficiently adhere directly to the retroreflective layer. Accordingly, in one aspect the intermediate layer provides an adhesion layer, exhibiting good adhesion to both the retroreflective layer and the hardcoat layer. The sufficiency of the adhesion between the hardcoat and the retroreflective layer can be evaluated according to ASTM Test Method D522-93A (2001) “Standard Test Methods for Mandrel Bend Test of Attached Organic Coatings” or ASTM Test Method D2794-93 (1999)e1 “Standard Test Method for Resistance of Organic Coatings to the Effects of Rapid Deformation (Impact)”.

In view of the hardness and brittleness of the hardcoat layer in comparison to the flexible retroreflective layer, the hardcoat layer can exhibit a tendency to crack and chip off. Thus, in another aspect, the intermediate layer(s) provide a gradient in hardness and flexural strength between such layers. Accordingly, the intermediate layer preferably exhibits a flexural strength, measured using ASTM Test Method D522-93A, and hardness, measured using ASTM Test Method D785-98 “Standard Test Method for Rockwell Hardness of Plastics and Electrical Insulating Materials”, less than the hardcoat layer, yet greater than the retroreflective layer. Additionally, loss of retroreflective performance may be measured using an abrasion resistance test such as ASTM Test Method D4060-01 “Standard Test Method for Abrasion Resistance of Organic Coatings by Taber Abraser”.

A preferred class of materials for the intermediate layer that has been found to have the desired adhesion, hardness and flexural properties, particularly in the case of inorganic oxide based hardcoat materials are thermal cured silicone hardcoat resins such as commercially available from General Electric Company, Schenectady, N.Y. under the trade designation “GE SHC 5020”. Preferred intermediate materials for diamond-like carbon hardcoats include polysiloxanes and ceramer hardcoats, such as described in WO 01/18082, U.S. Pat. No. 5,677,050, as well as adhesion-enhancing coatings such as described in WO 99/38034.

In the case of raised pavement markers, the molded resinous material for use as the body member may comprise a wide variety of suitable thermoset and engineered thermoplastic materials such as epoxy, polyester, polycarbonate, acrylic, and polyurethane resins. Preferably, the resinous, inorganically filled, thermoset material is an organic resinous material such as a curable polyester or epoxy resin. Such resinous materials are durable and show resistance to the degrading effects of long term environmental exposure, such as, for example, exposure to weathering and ultraviolet light. Polyester resins are generally less expensive than epoxy resins. Epoxy resins are preferred when automated marker production methods are used because of their superior structural characteristics, including high flexural stress and impact resistance and good adhesion to highway substrates. More preferably, the resinous engineered thermoplastic materials such as fiber reinforced polycarbonates matched performance as filled thermoset materials while lowering the weight of the raised pavement markers. In addition the high volume production, injection molding process allows much greater economic feasibility in producing engineered thermoplastic material raised pavement markers.

The resinous material preferably contains a substantial amount of inert additives, such as, for example, silica, calcium carbonate, glass beads or combination thereof. Such additives can help give abrasion and impact resistance. The resinous material can contain from about 50% to about 80% by weight of such an additive.

In the case of pavement marking tapes, the backing typically comprises a polymeric material that has been admixed with various fibers, including for example non-thermoplastic organic fibers such as polyester fibers, polyolefin fibers and/or ceramic fibers. The polymeric material may comprise a thermoplastic material, such as disclosed in U.S. Pat. No. 5,536,569 (Lasch et al.), or a substantially non-crosslinked elastomer precursor. The elastomer precursor may partially crosslink when thermally blended with the ceramic fibers and other optional ingredients as well as when extruded into a sheet. For non-crosslinked elastomer polymeric material, the preferred concentration of fiber generally ranges from about 3 to about 20 weight-%, based on the total weight of the pavement marking composition, whereas in the case of thermoplastic polymeric materials, the preferred amount of fiber ranges from about 0.2 to about 10 weight-%. The amount of polymeric material is typically at least about 5 weight % and usually no more than about 50 weight-%. The amount of polymeric material preferably ranges from about 10 weight-% to about 30 weight-%. The pavement marking composition may optionally comprises up to about 75 weight-% of other ingredients selected from reflective elements (e,g, glass beads), extender resins, fillers and pigment. Although the fiber containing polymeric material typically exhibits such preferred properties and generally has sufficient strength alone, the pavement marking may optionally comprise a scrim, such as described in U.S. Pat. No. 5,981,033 incorporated herein by reference. The marking tape, and in particular the surface layer that contacts the pavement, is preferably conformable, meaning that it conforms to irregularities in the surface to which the tape is attached. Pavement marking tapes having an embossed top surface to improve reflectivity and other properties, such as embossed sheeting as described in U.S. Pat. No. 4,388,359 and other embossed forms of pavement marking sheet material, are also taught in the art. Pavement marking tapes may also have a metallic conformable layer as described in U.S. Pat. No. 6,127,020 (Bacon Jr. et al.).

The pavement marking articles, especially the tapes, typically comprise a pressure sensitive adhesive for bonding the sheet to a roadway surface. Suitable adhesive compositions may comprises a wide variety of non-thermoplastic hydrocarbon elastomers including, natural rubber, butyl rubber, synthetic polyisoprene, ethylene-propylene rubber, ethylene-propylene-diene monomer rubber (EPDM), polybutadiene, polyisobutylene, poly(alpha-olefin) and styrene-butadiene random copolymer rubber. These elastomers are distinguished from thermoplastic elastomers of the block copolymer type such as styrenic-diene block copolymers which have glassy end blocks joined to an intermediate rubbery block. Such elastomers are combined with tackifiers as well as other optional adjuvants. Examples of useful tackifiers include rosin and rosin derivatives, hydrocarbon tackifier resins, aromatic hydrocarbon resins, aliphatic hydrocarbon resins, terpene resins, etc. Typically the tackifier comprises from 10 to 200 parts by weight per 100 parts by weight of the elastomer. Such adhesive compositions are preferably prepared according to the methods described in U.S. Pat. Nos. RE 36,855 and 6,116,110, incorporated herein by reference. Alternatively, and in particular for raised pavement markers, the markers may be secured to the roadway with a mechanical fastening means.

Other preferred adhesive compositions include acrylate based pressure sensitive adhesive composition such as described in further detail in WO 98/24978 published Jun. 11, 1998 that claims priority to U.S. Ser. Nos. 08/760,356 and 08/881,652, incorporated herein by reference. Preferred acrylate based adhesive compositions include four types of compositions, namely i) compositions comprising about 50 to 70 weight-% polyoctene and about 30 to 40 wt-% tackifier; ii) compositions comprising about 60 to 85 wt-% isooctyl acrylate, about 3 to 20 wt-% isobornyl acrylate, about 0.1 to 3 wt-% acrylic acid and about 10 to 25 wt-% tackifier; iii) compositions comprising about 40 to 60 wt-% polybutadiene and about 40 to 60 wt-% tackifier; and iv) compositions comprising 40 to 60 wt-% natural rubber and about 40 to 60 wt-% tackifier.

Objects and advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

### Example 1

### Thin Inorganic Oxide Hardcoat

A sheet of retroreflective material consisting of about a 1250 micron thick layer of polycarbonate resin having a rear surface patterned with a cube corner prismatic retroreflecting structure and having a front surface covered by about a 50 micron thick layer of acrylic resin was coated on the outer surface of the acrylic layer with a silicone hardcoat commercially available from General Electric Company, Schenectady, N.Y. under the trade designation “GE SHC 5020”. The silicone hardcoat was spray coated at a thickness of approximately 6 to 8 microns and cured according to the manufacturer recommendations as described in the GE SHC 5020 product literature. A layer of SiO₂ approximately 4 to 6 microns in thickness was then deposited on the surface of the silicone hardcoat by chemical vapor deposition using plasma enhanced chemical vapor deposition.

Several days after preparation, the sheet was tested for abrasion resistance following the method in ASTM D 4280 “Standard Specification for Extended Life Type, Nonplowable, Prismatic, Raised Retroreflective Pavement Markers”. A 25.4 millimeter diameter pad of No. 3 coarse steel wool was placed on the SiO₂ coated surface. A load of 22 kg was applied to the steel wool pad and the surface was rubbed with the load 100 times. No visible signs of scratching or abrasion through the hardcoat were visible after testing.

The sheet was also tested for Graffiti Resistance by drawing a fine line of approximately 3 centimeters on the SiO₂ coated surface using a black fine point permanent marker commercially available from Sanford Corporation, Bellwood, Ill. under the trade designation “Sharpie”. The sample was stored at room temperature for about 24 hours. The sample was then wiped with both a wet and dry tissue and was found to leave a very small amount to no ink after wiping.

The retroreflective layer coated with the thin inorganic oxide layer can be cut from the coated sheet material in a desired shape and size for attachment to a backing for use as a pavement marker. While coating sheet material is preferred for coating efficiency, alternatively the backing having the retroreflective layer may also be coated with an intermediate layer and then the thin inorganic oxide layer.

### Examples 2

### Thin Diamond-Like Carbon Hardcoats

DLC films were deposited with a commercial reactive ion plasma etching reactor, commercially available from Plasmatherm Inc (Boca Raton, Fla.) under the trade designation “Plasmatherm Model 2480” onto the lens (i.e. retroreflective surface) of a pavement marker commercially available from 3M Company, St. Paul, Minn. under the trade designation “3M Marker Series 290”. The lens was placed on the powered electrode and pumped down to a base pressure of 4 mTorr. Prior to deposition, the lens was cleaned in an argon plasma for 10 seconds at a pressure of 25 mTorr and a power of 1 kW. For the DLC deposition, trans 2-butene diluted with argon was used as the precursor gas with a flow rate of 500 standard cubic centimeters per minute and total power of 1 kW. Optical density was measured at a wavelength of 630 nm (red light). The extinction coefficient of the films was grown under he following conditions was measured and a correlation developed. The correlation was used to estimate the deposition time required to obtain the desired optical density value.

| | Optical | | Deposition | |
|---|---|---|---|---|
| Ex. No. | Density | % Argon | Time | Film Thickness |
| 2 | 0.12 | 0% | 230 seconds | 6817 angstroms |
| 3 | 0.12 | 40% | 177 seconds | 4090 angstroms |
| 4 | 0.12 | 80% | 101 seconds | 1363 angstroms |
| 5 | 0.08 | 0% | 154 seconds | 4544 angstroms |
| 6 | 0.08 | 40% | 118 seconds | 2726 angstroms |
| 7 | 0.08 | 80% | 69 seconds | 909 angstroms |
| 8 | 0.04 | 0% | 76 seconds | 2272 angstroms |
| 9 | 0.04 | 40% | 60 seconds | 454 angstroms |

The abrasion resistance was tested using ASTM D 4280, as previously described except that #4 steel wool was employed with a load of 50 psi. No visible signs of scratching or abrasion through the hardcoat were visible after testing.

What is claimed is:

1. A retroreflective sheeting suitable for pavement marking comprising a retroreflective layer having an exposed surface and a continuous hardcoat layer disposed on the exposed surface of the retroreflective layer wherein the hardcoat layer comprises an inorganic oxide material at a thickness of less than about 25 microns or a diamond-like carbon material at a thickness of less than about 10 microns.

2. The retroreflective sheeting of claim 1 wherein the hardcoat layer has a hardness equal to or greater than sand.

3. The retroreflective sheeting of claim 1 wherein the hardcoat layer comprises an inorganic oxide material and the thickness is less than about 20 microns.

3. The retroreflective sheeting of claim 1 wherein the hardcoat layer comprises an inorganic oxide material and the thickness is less than about 10 microns.

4. The retroreflective sheeting of claim 1 wherein the thickness of the hardcoat layer comprises an inorganic oxide material and the thickness is at least about 0.5 microns.

5. The retroreflective sheeting of claim 1 wherein the hardcoat layer comprises an inorganic oxide material and the thickness is at least about 1.0 micron.

6. The retroreflective sheeting of claim 1 wherein the hardcoat layer comprises an inorganic oxide layer material and the thickness is at least about 2.0 micron.

7. The retroreflective sheeting of claim 1 wherein the hardcoat layer comprises diamond-like carbon and the thickness is less than about 5 microns.

8. The retroreflective sheeting of claim 1 wherein the hardcoat layer comprises diamond-like carbon and the thickness is at least about 200 angstroms.

9. The retroreflective sheeting of claim 1 wherein the hardcoat layer comprises diamond-like carbon and the thickness is at least about 400 angstroms.

10. The retroreflective sheeting of claim 1 wherein the hardcoat layer comprises diamond-like carbon and the thickness is at least about 800 angstroms.

11. The retroreflective sheeting of claim 1 wherein the inorganic oxide material comprises a major amount of an inorganic oxide selected from TiO₂, Al₂O₃, ZrO₂, ZnO and SiO₂.

12. The retroreflective sheeting of claim 11 wherein the inorganic oxide comprises a major amount of SiO₂.

13. The retroreflective sheeting of claim 1 further comprising an intermediate layer disposed between the retroreflective layer and the hardcoat layer.

14. The retroreflective sheeting of claim 13 wherein the intermediate layer has a hardness less than the hardcoat layer and greater than the retroreflective layer.

15. The retroreflective sheeting of claim 13 wherein the intermediate layer has a flexural strength less than the hardcoat layer and greater than the retroreflective layer.

16. The retroreflective sheeting of claim 13 wherein the intermediate layer has good adhesion to the retroreflective layer and hardcoat layer.

17. The retroreflective sheeting of claim 1 wherein the hardcoat layer is applied by chemical vapor deposition.

18. A retroreflective article comprising the sheeting comprising a retroreflective layer having an exposed surface and a continuous hardcoat layer disposed on the exposed surface of the retroreflective layer wherein the hardcoat layer comprises an inorganic oxide material at a thickness of less than about 25 microns or a diamond-like carbon material at a thickness of less than about 10 microns.

19. The retroreflective article of claim 18 further comprising a backing.

20. The retroreflective article of claim 19 wherein the backing is a body member comprising a resinous material and inert additives.

21. The retroreflective article of claim 20 wherein the body member comprises at least one vertically inclined face or at least one elevated horizontal face.

22. The retroreflective article of claim 21 wherein the retroreflective layer is disposed on a vertically inclined face.

23. The retroreflective article of claim 21 wherein the retroreflective layer is disposed on a horizontally elevated face.

24. The retroreflective article of claim 21 wherein the retroreflective layer is disposed on a vertically inclined face and a horizontal face.

25. The retroreflective article of claim 19 wherein the backing comprises a polymeric material comprising fibers.

26. The retroreflective article of claim 19 wherein the backing further comprises an adhesive.

27. The retroreflective article of claim 1 wherein the hardcoat is transparent.
